(19) United States
(12) Patent Application Publication
(10) Pub. No.: US 2006/0002317 A1
(43) Pub. Date: Jan. 5, 2006

(54) Information feeder framework

(76) Inventor: Murali Krishna Punaganti Venkata, Vantaa (FI)

Correspondence Address: Hollingsworth & Funk, LLC, Suite 125, 8009 34th Avenue South, Minneapolis, MN, 55425, US

(21) Appl. No.: 10/884,793

(22) Filed: Jul. 1, 2004

(51) Int. Cl. H04B 7/00

(52) U.S. Cl. 370/310

(57) ABSTRACT

An information feeder network provides data to a data processing arrangement coupled to a service element via a network. A content-defined information feed of the service element is selected. The information feed is sent from the service element to the data processing arrangement. An application of the data processing arrangement is selected for receiving the information feed based on a predetermined association between a content-type of the information feed and a content-type of the application. The information feed is sent to the application for utilization by the application.

### FIELD OF THE INVENTION

This invention relates in general to communications devices, and more particularly to communications devices configured for receiving information feeds via a network.

### BACKGROUND OF THE INVENTION

Mobile communications devices such as cell phones are gaining wider acceptance due to the capabilities being added to such devices. Far from being simple voice communications tools, modem cell phones and other mobile devices are high technology devices whose availability has resulted in the widespread adoption of personal digital communications.

One factor that is expected to increase the popularity of mobile devices is the development of third generation (3G) technologies. The designation 3G refers to a collection of standards and technologies that can be used in the near future to enhance performance and increase data speed on cell phone networks. In particular, 3G is an International Telecommunication Union (ITU) specification for the third generation of mobile communications technology. A 3G cell phone would, in theory, be compatible with the 3G languages or standards which support enhanced data speeds.

The 3G infrastructure aims to provide packet-switched data to a handheld terminal with data bandwidth measured in hundreds of Kbits/sec. It is intended that 3G will work over wireless air interfaces such as Code Division Multiple Access (CDMA), Wideband CDMA (W-CDMA), and the Time Division Multiple Access (TDMA) based General Packet Radio Service (GPRS). The latter interface is included in the Enhanced Data for GSM, Environment (EDGE) air interface that has been developed specifically to meet the bandwidth needs of 3G cell phones.

Because cell phones include data processing capabilities, 3G cell phones will be able to handle some data-handling applications currently associated with desktop and notebook personal computers. These applications allow users to create, modify, and view various types of data. The data paradigm with which most computer users are familiar with is an application data-format paradigm. In this paradigm, each data-format on the system is associated with one or more applications. A data-format generally includes the type and arrangement of bytes in an instantiation of the data type. For example, a BMP formatted bitmap file is arranged in a particular binary data format. An application that is associated with a BMP file typically has facilities for opening the file, determining the image size and color information by reading a binary header, then constructing a view of the image based on the data contained in the remainder of the file.

The application data-format paradigm of computing is familiar to most experienced computer users, although can be confusing for novices. Upon receiving a file of interest in an email, for example, a novice user is likely to care more about viewing the content of the message and care less about which application is used to view it. Although many software vendors insist on proprietary formats, there are an increasing number of open formats that can be used to describe, store, and transfer all sorts of data in many different applications.

One example of an open format is the Extensible Markup Language (XML). XML is a language for creating documents having structured information. Structured information may include both content and data that describes meaning of content in the context of the document. An XML document may include traditional document content such as user-readable text, as well as any other collections of structured information. Although XML is sometimes called a markup language, it is more accurate to say that XML a meta-language for describing markup languages. In other words, XML provides a facility to define tags and the structural relationships between them.

Unlike the ubiquitous Hypertext Markup Language (HTML) used on the Internet, there is no predefined tag set in XML. Applications that can interpret XML can either define their own semantics or interpret them based on stylesheets. Therefore, XML is designed to present data in such a way that it is not necessarily tied to the requirements or strictures of particular applications. For example, data within an XML document may be easily displayed and viewed in a browser, while at the same time a financial accounting program may provide an entirely different view of all or part of the same XML document.

The use of XML is only one example of separating data formats from particular application content. Such a content-centric paradigm allows the data to be accessed by a variety of applications, and is therefore much more useful in the real world. The content itself holds the most value to the end-user, so a content-oriented paradigm is likely much easier to grasp for a novice computer user than a data-format paradigm. For example, a collector of stamps may just want an intuitive way to view, buy, sell, and discuss stamp collecting utilizing the Internet. To do this currently, the stamp collector is forced to understand that certain actions require an email application, other actions require a Web browser, and still other actions may require a proprietary viewer/editor. While these applications and their uses make sense to those who have overcoming the computer learning curve, that learning curve may be a waste of time for somebody who only cares about stamp collecting, and has no other interest in how computers work.

Of course, a custom and/or proprietary framework that presents a single “picture” of stamp collecting over the Internet could be developed. However, in order for such an arrangement to work, it would need a critical mass of users to attract the interest and investment needed. For less popular or less lucrative activities, this is not likely to occur. Instead, the stamp collection activities may be carried out through a more commonplace (though sometimes less effective) combination of Web pages, email communications, online auctions, third-party payment brokers, etc.

Activities that are enhanced by data communications, such as stamp collecting, share some common threads. In these activities, data is defined by its content rather than its format, and the data is presented in such as way to meet the particular needs of a select group of individuals. Therefore, an enthusiast in any field of endeavor is much more interested in dealing with a subset of incoming data if the content of that data is relevant the recipient's interests. This is not to say that data format is irrelevant. For example, the stamp collector is more likely to care about text and images than a streaming audio feed in the activity of stamp collecting, although they might find useful applications for the latter data-type (e.g., listening to a live stamp auction). Whatever the format, though, the stamp collector is likely to find a data source much more valuable if the “signal-to-noise” ratio (that is the ratio of relevant to irrelevant information) is high.

Given the power and portability of 3G mobile communications devices, it is much more likely that these devices will be used for both creating and viewing an increasing amount of data content available via the Internet and other networks. Therefore, providing additional data communications capabilities via mobile communications devices may require adapting the devices in ways that may not have been envisioned in the design of mobile communications architectures.

### SUMMARY OF THE INVENTION

The present disclosure relates to a system, apparatus and method for providing information to a data processing arrangement coupled to a service element via a network. In one embodiment, a content-defined information feed of the service element is selected. The information feed is sent from the service element to the data processing arrangement. An application of the data processing arrangement is selected for receiving the information feed based on a predetermined association between a content-type of the information feed and a content-type of the application. The information feed is sent to the application for utilization by the application.

In more particular embodiments, selecting the application for receiving the information feed may involve registering one or more content-types of the application via an application program interface of the data processing arrangement. The application is selected for receiving the feed based on the registered content-types. The method may also involve registering, with the service element, one or more content-types associated with applications of the data processing arrangement.

In another, more particular embodiment, the method may further involve receiving data at the service element from a plurality of data sources, aggregating the data at the service element, and forming the information feeds based on the aggregated data. The plurality of data sources may include a peer of the data processing arrangement and/or a content provider. Aggregating the data may involve removing redundant data and/or determining content-type associations of the data. The data processing arrangement may include a mobile terminal.

In another embodiment of the invention, a processor-readable medium includes a program storage device configured with instructions. The instructions cause a processor of a data processing arrangement coupled to a service element via a network to perform operations that include: 1) selecting a content-defined information feed originating from the service element; 2) receiving the information feed from the service element; 3) selecting an application for receiving the feed based on a predetermined association between content-types of the information feed and a content-type of application; and 4) sending the information feed to the selected application for utilization by the selected application.

In another embodiment of the present invention, a system includes a network and a service element coupled to the network. The service element includes means for sending information feeds via the network. A data processing arrangement is coupled to the service element via the network. The data processing arrangement includes 1) means for selecting a content-defined information feed of the service element; 2) means for receiving the selected information feed via the network; 3) means for selecting an application of the data processing arrangement for receiving the feed based on a predetermined association between a content-type of the information feed and a content-type of the application; and 3) means for delivering the information feed to the application.

In a more particular embodiment, the data processing arrangement further includes means for registering one or more content-types of the application via an application program interface of the data processing arrangement. The data processing arrangement may also include means for registering, with the service element, one or more content-types associated with applications of the data processing arrangement.

In one arrangement, the service element further includes 1) means for receiving data at the service element from a plurality of data sources; 2) means for aggregating the data at the service element; and 3) means for forming the information feeds based on the aggregated data.

In another embodiment of the present invention, an apparatus is configured for exchanging data with a service element via a network. The apparatus includes a network interface configured to exchange data with the service element via the network. A processor is coupled to the network interface. The apparatus includes a data storage arrangement containing one or more applications and an information feed module. The information feed module includes instructions that cause the processor to: 1) select a content-defined information feed of the service element via the network interface; 2) receive the selected information feed via the network interface; 3) determine a selected application of the one or more applications for receiving the feed based on a predetermined association between a content-type of the information feed and a content-type of the selected application; and 4) deliver the information feed to the selected application.

In a more particular embodiment, the information feed module is further configured to cause the processor to accept registration of one or more content-types of the applications via an application program interface of the information feed module, and select the application for receiving the feed based on the registered content-types. The information feed module may be configured to cause the processor to register, with the service element, one or more content-types associated with the applications of the apparatus. In one configuration, the network interface comprises a wireless network interface.

In another embodiment of the present invention, an apparatus is configured for exchanging data with a client terminal via a network. The apparatus includes a network interface configured to exchange data with the client terminal via the network. A processor is coupled to the network interface. The apparatus includes a data storage arrangement containing instructions that cause the processor to: 1) receive data from a plurality of data sources via the network; 2) aggregate the data into one or more content-defined information feeds; 3) receive from the client terminal a request for one of the content-defined information feeds of the apparatus; and 4) send to the client terminal the selected information feed via the network interface.

In a more particular embodiment, the plurality of data sources may include a peer of the data processing arrangement and/or a content provider. In one configuration, aggregating the data may involve removing redundant data and/or determining content-type associations of the data.

### BRIEF DESCRIPTION OF THE DRAWINGS

The invention is described in connection with the embodiments illustrated in the following diagrams.

FIG. 1 illustrates an information feeder framework system according to embodiments of the present invention;

FIG. 2 illustrates a mobile device adapted for use with an information feeder network according to embodiments of the present invention;

FIG. 3 illustrates a software architecture for an information feeder system according to embodiments of the present invention;

FIG. 4 illustrates a software architecture for an information feeder client according to embodiments of the present invention; and

FIG. 5 illustrates information feeder data exchange sequences according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a framework for providing specialized information feeds to mobile devices. The information feeds may be selected based on content-type and sent to mobile devices having a common application program interface (API). The API may include a way for applications to register for particular information feeds. The API may also provide a way for applications to modify the information feeds. The information feeds may be sent automatically to the user, or the user may have a mechanism to selectively control whether a feed and/or a particular piece of data within an information feed are to be received.

The concepts described herein regarding an information feeder framework are applicable to any type of communication systems, devices, and networks. In order to facilitate an understanding of the invention, the present invention is described in the context of mobile devices in a wireless networking environment. It will be appreciated, however, that the invention may be applicable in any system or application where sending data feeds to data processing devices is desired.

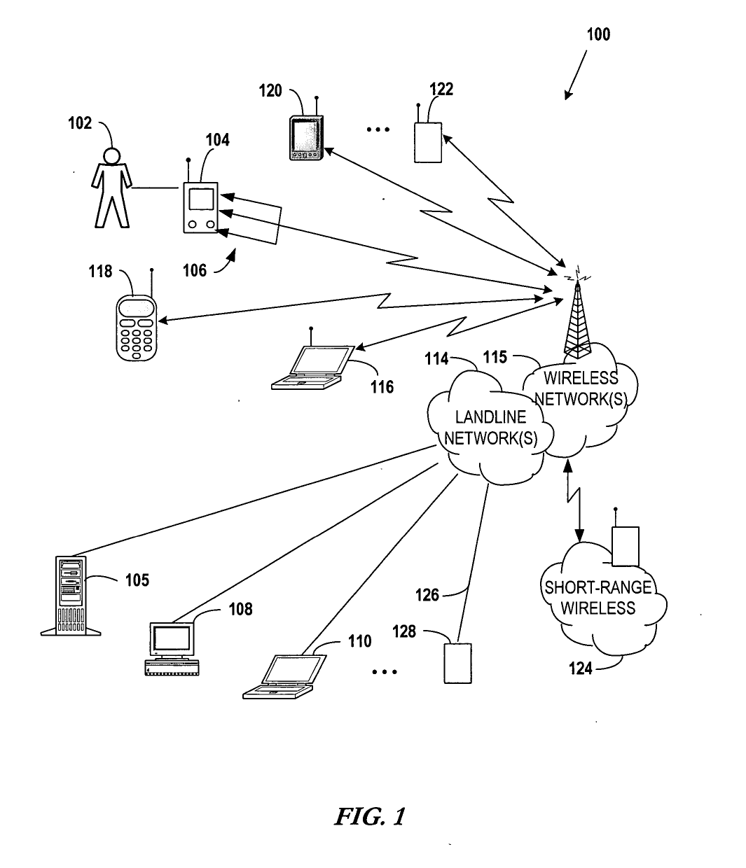

It will be appreciated that many Internet services exist that cater to specialized interests, such as Web sites, emailing lists, chat rooms, Web logs, and Usenet groups. What is lacking, however, is a way to unify this diverse data into a single view that is of use to the end user. What is needed, then, is the formation of specialized information feeds that provide a coherent and filtered set of data that can be highly tailored based on the interests of the end user. This scenario is illustrated in FIG. 1, which shows a framework 100 for specialized information feeds according to embodiments of the present invention.

In FIG. 1, an end user 102 interacts with a data processing arrangement such as a mobile communications device 104. For purposes of illustration, the concepts will be described in terms of the user 102 interacting with a mobile communications device 104, although it will be appreciated that the information feeder framework 100 may be utilized with any type or manner of data processing arrangement.

In accordance with the desires of the user 102, the mobile communications device 104 is configured to receive various information feeds 106. Each information feed 106 includes a sequence of incoming data that may be defined by one or more user-selectable parameters. The user-selectable parameters may include data content and data formats. Once the user 102 has configured the information feeds, 106, the data may be “pushed” out to the user 102 without any further action on behalf of the user 102. Of course, some user interaction may be desirable to allow limiting some data received via the information feeds 106. Limiting the information feeds 106 may be accomplished, for example, by requiring user confirmation before an information feed 106 is activated or a particular piece of data is pushed to the user's device 104 via a currently active information feed 106.

As previously described, the information feeds 106 may be implemented as a collection of data that is pushed to the client device 104. The information feeds 106 may originate from any data source of the information feed framework 100, including servers 105 and peers of the communication device 104 (e.g. device 122). It will be appreciated that the information feeds 106 may also be two-way communications channels, such that the user 102 may also send data out via the feeds 106. The outgoing data may be directed towards a server 105 or peers 122 as appropriate.

The information feeds 106 may be communicated between target devices in any number of known manners. These manners include via a landline network(s) 114, which may include a Global Area Network (GAN) such as the Internet, one or more Wide Area Networks (WAN), Local Area Networks (LAN), and the like. Any computing device or other electronic device that supports network data exchanges may be the target system that utilizes the present invention, such as servers 105, desktop computers 108 or workstations, laptop or other portable computers 110, or any other similar computing device capable of communicating via the network 114, as represented by generic device 128.

The information feeds 106 may be communicated via one or more wireless networks 115, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device can communicate using information feeds 106, such as laptop or other portable computers 116, mobile phones 118 and other mobile communicators, Personal Digital Assistants (PDA) 120, or any other similar computing device capable of communicating via the wireless network 114, as represented by generic device 122.

The information feeds 106 may be transferred between devices using short-range wireless technologies 124, such as Bluetooth, Wireless Local Area Network (WLAN), infrared (IR), etc. The information feeds 106 can also be distributed using direct-wired connections, such as depicted by connection path 126 to generic wired device 128. The present invention is applicable regardless of the manner in which data is provided or distributed between the target devices.

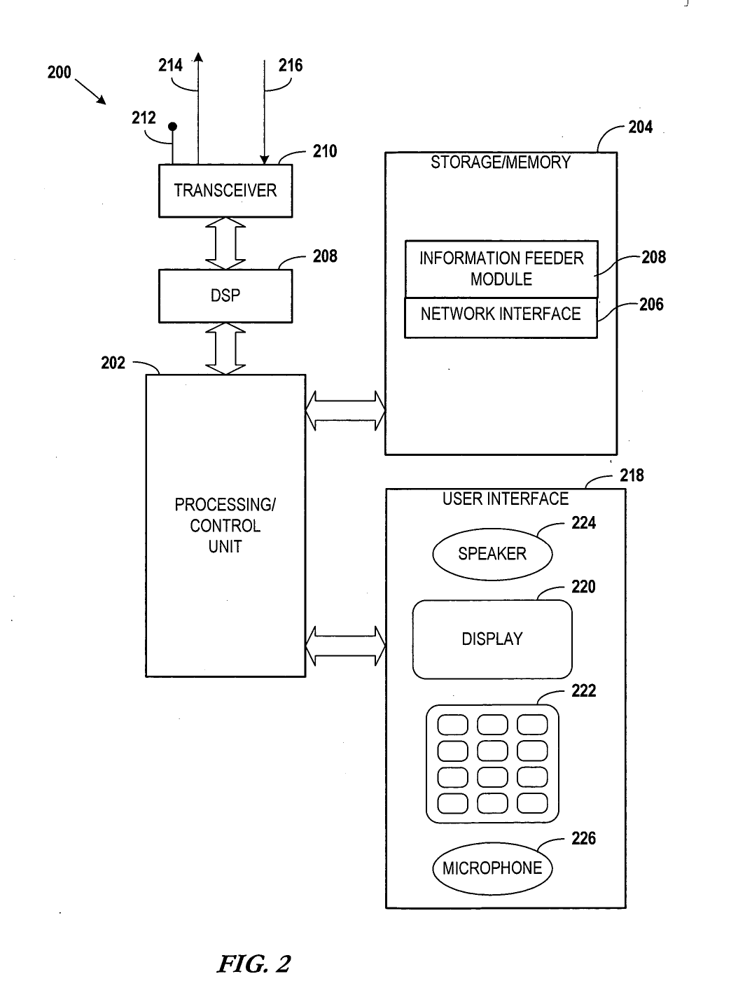

An example of a target device that utilizes information feeds according to embodiments of the present invention is illustrated in FIG. 2 as the mobile computing arrangement 200. Those skilled in the art will appreciate that the exemplary mobile computing arrangement 200 is merely representative of general functions that may be associated with such mobile devices, and also that landline computing systems similarly include computing circuitry to perform such operations.

The mobile computing arrangement 200 is suitable for processing one or more information feeds in accordance with embodiments of the present invention. The representative mobile computing arrangement 200 includes a processing/control unit 202, such as a microprocessor, reduced instruction set computer (RISC), or other central processing module. The processing unit 202 need not be a single device, and may include one or more processors. For example, the processing unit 202 may include a master processor and associated slave processors coupled to communicate with the master processor.

The processing unit 202 controls the basic functions of the mobile computing arrangement 200. Those functions associated may be included as instructions stored in a program storage/memory 204. The program storage 204 may include one or more of read-only memory (ROM), flash ROM, programmable and/or erasable ROM, random access memory (RAM), subscriber interface module (SIM), wireless interface module (WIM), smart card, or other removable memory device.

In one embodiment of the invention, the program modules associated with the storage/memory 204 are stored in non-volatile electrically-erasable, programmable ROM (EEPROM), flash ROM, etc. so that the information is not lost upon power down of the mobile computing arrangement 200. The relevant software for carrying out conventional mobile terminal operations and operations in accordance with the present invention may also be transmitted to the mobile computing arrangement 200 via data signals, such as being downloaded electronically via one or more networks, such as the Internet and an intermediate wireless network(s).

In one arrangement, the program storage/memory 204 includes software modules such as a network interface module 206 and an information feed processing module 208. The information feed processing module 208 allows configuration and management of information feeds via the network interface 206. The network interface 206 may include software components (e.g., drivers, protocol stacks) that allow data transfers over wired or wireless network devices of the mobile computing arrangement 200.

The network interface 206 may include drivers and other software components for communicating with circuitry coupled to the processing/control unit 202 for performing wireless data transmissions. This circuitry may include a digital signal processor (DSP) 208 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 210, generally coupled to an antenna 212, transmits the outgoing radio signals 214 and receives the incoming radio signals 216 associated with the wireless device 200.

The processor 202 is also coupled to user-interface 218 elements associated with the mobile terminal. The user-interface 218 of the mobile terminal may include, for example, a display 220 such as a liquid crystal display, a keypad 222, speaker 224, and microphone 226. These and other user-interface components are coupled to the processor 202 as is known in the art. Other user-interface mechanisms may be employed, such as voice commands, switches, touch pad/screen, graphical user interface using a pointing device, trackball, joystick, or any other user interface mechanism.

The mobile computing arrangement 200 of FIG. 2 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

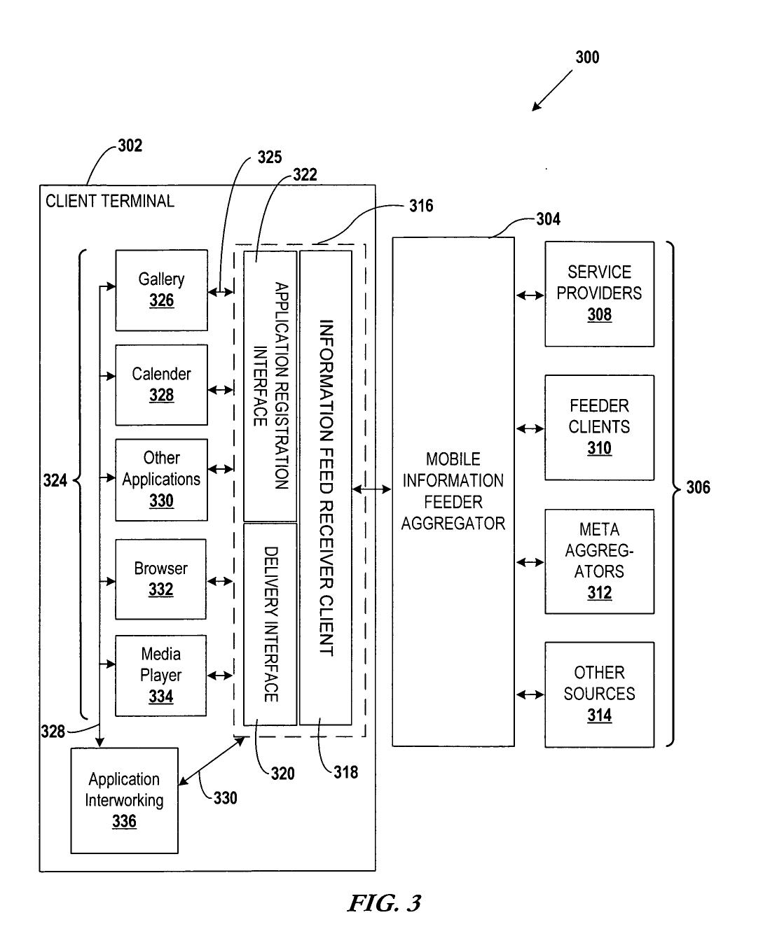

The information feeder module 208 shown in FIG. 2 is one software component of a network-based information feeder framework designed to provide user-selectable data to feeder modules such as 208. FIG. 3 shows, in greater detail, software components of an information feeder framework 300 according to embodiments of the present invention. The framework 300 includes a client terminal 302, a mobile information feeder/aggregator 304 and various information feed data sources 306. The client terminal 302 acts as a network endpoint for information feeds. This generally means the client terminal 302 is a receiver of information feeds, although the client terminal 302 may also act as a source of information feed data as well. The client terminal 302 may act as the sole provider of an information feed, although more typically data originating from the terminal 302 will be sent through a feeder/aggregator 304.

The feeder/aggregator 304 acts as a point for aggregating, categorizing, and correlating information feed data, as well as for managing data-connection aspects of the client information feeds. The information that is sent to the feeder/aggregator 304 may come from a variety of sources 306, including specialized service providers 308, other feeder clients 310, meta-aggregators 312 (e.g., other feeder/aggregators 304), and other sources 314. It will be appreciated that the feeder/aggregator 304 should be able to handle various formats of data as well as being able to categorize various types of content.

The feeder/aggregator 304 may gather disparate data from a variety of sources, such as Web pages, emails, file repositories, etc. The feeder/aggregator 304 may also aggregate existing data feeds. For example, the feeder aggregator may present a sports feed that includes feeds from a variety of sports-related feeder networks. The data processed by the feeder/aggregator 304 may be single-part or multi-part content. Since the information received at the feeder/aggregator 304 comes from a variety of sources 306, mechanisms may be employed to identify and disregard redundant or irrelevant data.

Information feeds sent from the feeder/aggregator 304 to the client terminal 302 are processed by an information feed processing module 316. This module 316 may include a receiver client 318, an information delivery interface 320, and an application registration interface 322. The receiver client component 318 acts as an interface to one or more feeder/aggregators 304. The receiver client 318 may handle tasks such as listening for connections, listening for incoming data, sending outgoing data, handling lost/interrupted connections, demultiplexing multiple information feeds, and the like.

The receiver client 318 will typically depend on the information delivery interface 320 to deliver incoming data to the appropriate applications 324 of the client terminal 302. The information delivery interface 320 may handle such tasks as starting the necessary application 324 and transferring the data to the applications 324. Similarly, applications 324 that can send outbound data through information feeder channels may send that data via the information delivery interface 320.

The information delivery interface 320 works in concert with the application registration interface 322 to automatically and transparently deliver incoming data feeds to the appropriate applications 324. The application registration interface 322 is used by applications 324 to register the type of data the applications 324 can handle. The applications 324 may register for data based on format, content, protocols, bandwidth required, or any other aspect that may be appropriate. Multiple applications 324 may register for the same or similar data, and the application registration interface 322 may coordinate with the information delivery interface 320 to resolve conflicts.

The example applications 324 in FIG. 3 include a picture gallery 326 for storing pictures by content, a calendar application 328, a browser 332, a media player 334, and any other application 330 as are known in the art. The applications 324 may communicate directly with the information feed processing module 316, as illustrated by path 325. This communication path 325 may be accomplished by any combination of library calls, system calls, or inter-process communications (IPC). In another arrangement, the client terminal may include an application inter-working component 326. The application inter-working component 326 is typically used to provide inter-application communications, such as illustrated by path 328. It will be appreciated that communications between the applications 324 and the information feed processing module 316 may also be facilitated by the application inter-working component 326, as illustrated by path 330.

In many configurations, multiple applications may deal with the same or similar data types. For example, the picture gallery 326 may be registered with the application registration interface 322 to accept still or moving image files (e.g., JPEG, PNG, WMV, etc.) related to a hobby of the user, such as bird watching. The browser 332 and media player 334 may also be registered to handle certain types of image files, although the applications 332, 334 may not be associated with a particular type of content. Therefore, if an image file relating to bird watching arrives at the receiver client 318, the information delivery interface 320 can determine that the images relate to bird watching (e.g., through association with a bird watching related feed, through examination of protocol header values, or other methods that may be used to describe message content). The information delivery interface 320 can query the application registration interface 322 to determine whether any applications 324 (in this case the picture gallery 326) are registered for this content and format, and then deliver the image to that application 324.

Under the same configuration as described above, the client terminal 302 may also receive image data from a weather feed, which occasionally sends out a radar map images showing weather patterns of the local area. If no applications 324 have registered for weather related content, the information delivery interface 320 can send the images to a default application 324 that is registered for the image format type. The selection of a default application 324 may be predetermined by a system default, by a user preference, or by a dynamic user prompt.

In other scenarios, it may be that an XML document describing a bird watching meeting arrives via the receiver client 318. Although the picture gallery application 326 has registered for bird watching content, it may be the case that the gallery application 326 does not know how to display an XML document. In this case, the information delivery interface 320 may just send the document to another application that can handle XML documents. Alternatively, the information delivery interface 320 may have a converter that can convert an XML document to a graphic image. In this latter scenario, the information delivery interface 320 could convert the document to an image and send it to the picture gallery application 326 instead of or in addition to sending the document to an XML-handling application. Another approach is to extract the images from the XML document and send those images to gallery application 326.

In another arrangement, the picture gallery application 326 may be able to handle an embedded executable object, such as a Component Object Model (COM) object or a Java applet. In this case, the information delivery interface 320 may send to the data to the picture gallery application 326 along with the object (or a reference to that object) that allows the gallery application 326 to display the XML document. In this way, the picture gallery application 326 could be adapted to handle a wide variety of content for which it was not originally designed. From the user's perspective, it is preferable to view the XML document in the gallery application 326, since the user already accesses other bird-watching content in this application 326.

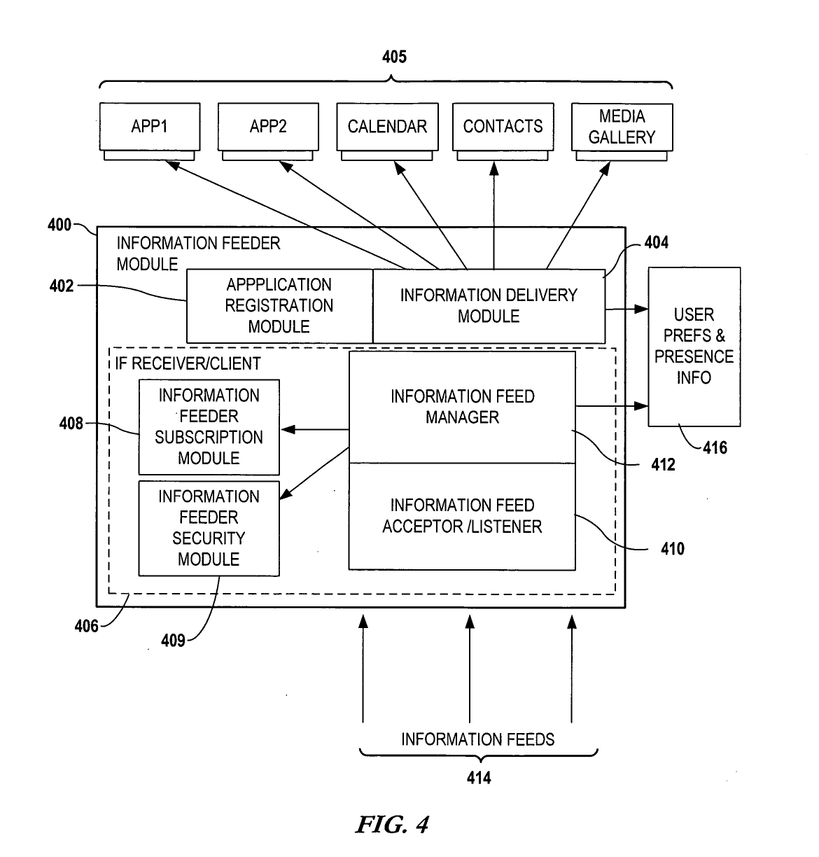

A more detailed view of an information feeder module 400 according to embodiments of the present invention is shown in FIG. 4. The information feeder module 400 includes an application registration module 402 and information delivery module 404. These two modules 402, 404 generally correspond to the application registration interface 322 and the information delivery interface 320, respectively, that were described in relation to FIG. 3. In general, these modules 402, 404 interface with a plurality of applications 405 for purposes of providing information feed data to the applications 405.

The application registration module 402 provides moderation and control when provisioning data to the various applications 405. The application registration module 402 includes an application program interface (API) that allows the applications 405 to register and un-register for various information feeds. An application 405 desiring data from the information delivery module 404 will register this desire with the application registration module 402 via the API. Upon receiving incoming data, the information delivery module 404 can identify, via the registration module 402, which applications 405 can handle a particular type of content, and deliver the content to those applications 405 appropriately. In one arrangement, it may be possible to register and unregister the applications 405 for a content-type during the installation of the information feeder application 405 and/or feeder module 400. It is also be possible to provide an out-of-the box system with one or more information feeder client applications 405 already installed, registered, and linked to pre-determined information feeds of the feeder module 400.

A receiver/client module 406 is also shown as part of the information feeder module 400. The receiver/client module 406 generally handles external interactions with the network, and may include an information feeder subscription module 408, an information feeder security module 409, an information feed acceptor/listener 410, and an information feed manager 412. In general, the sub-modules 408, 409, 410, 412 of the receiver/client module 406 handle various tasks related to initiating, discovering, and handling a plurality of information feeds 414.

For example, the acceptor/listener 410 is the entry point for incoming data from the information feeds 414. The data may be transported by any data transfer mechanisms known in the art. For example, the information feeder module 400 may be employed on a mobile device that communicates using the Wireless Application Protocol (WAP™). WAP includes a set of open, extensible protocols and content formats that used as a basis for providing interoperability over wireless networks. One part of the WAP specification includes WAP Push specifications, which describe a service used to push content to mobile devices via the WAP architecture. Therefore, a WAP enabled device could utilize, via the acceptor/listener 410, a WAP push to receive information feeds 414. These information feeds 414 could be pushed to the end user at regular intervals, on an “as-available” basis, or at the express request of the user.

It will be appreciated that the information feeds 414 and associated software components (e.g., the acceptor/listener 410) may utilize additional or alternate network mechanisms besides WAP Push. For example, the 802.11 Wireless Local Area Networking (WLAN) standards are becoming widely adopted in portable devices. WLAN provides Transmission Control Protocol/Internet Protocol (TCP/IP) connections using radio transmissions. Therefore, mechanisms associated with TCP/IP and other Internet standards can be used to establish information feeds 414. In another example, the information feeds may be established by a terminal that establishes a data connection via GPRS.

As shown in FIG. 4, information feeds 414 may be accepted by being pushed to the user's device. The framework could also be arranged in such a way that information feeds 414 are pulled manually via the information feeder module 400. The feeds 414 could be retrieved whenever the end-user likes, or pulled periodically according to a schedule or timetable. The feeds 414 could be retrieved by data retrieval mechanisms known in the art, such as an HTTP GET.

When implemented with any of the above described technologies, the information feeds 414 may be continuous or intermittent in nature. A continuous feed would use an established connection that could be used to asynchronously receive data. An intermittent feed could be established for a set time, either based on a schedule or at the request of the user. The information feed acceptor/listener 410 will take such factors into account as part of initiating, maintaining, and closing the information feeds 414.

It will be appreciated that the information feed acceptor/listener 410 might be maintaining many information feeds 414 simultaneously. The information feed manager 412 may provide functionality to assist in maintaining different information feeds 414 to which the user has subscribed. For example, the information feed manager 412 may be accessed by the user to define information feeds of interest. The information feed manager 412 may work in concert with the subscription module 408 to store currently defined information feeds, as well as providing mechanisms for learning about and subscribing to additional feeds.

The subscription module 408 may include a predetermined list of standard information feeds 414 available to the user. The user may select from these predetermined feeds and connect to the selected feeds on a continuous or non-continuos basis. The subscription module 410 may provide mechanisms for advertising newly available feeds that the user may select from, as well as mechanisms for searching for and/or defining custom feeds based the user's specification.

The information feed manager 412 may act as an intermediary between the various sub-modules of the information feeder module 400. For example, the information feed manager 412 may act as a broker between the acceptor/listener 410 and the information delivery module 404 when routing incoming data from the information feeds 414 to the appropriate applications 405.

The information feeder security module 409 may also interact with the information feed manager 412. The security module 409 can be used to validate the various security aspects of the information feeds 414, including authorization to connect, validity of data obtained from the feeds 414, handling passwords associated with the information feeder module 400, data encryption, etc. Some of these security functions may be handled in cooperation with a user preferences module 416, which may be used to handle user data such as password management.

In general, the user preference module 416 may be accessed by the information feed manager 412 to handle various user preference and presence information. Presence refers to data and protocols that allow a portable data processing device to be uniquely located and identified as soon as the user connects to the network, wherever the device might be. Generally, the maintenance and access of presence data is coordinated between the portable device and various servers on the network. Therefore, the information feed manager 412 may need to access this presence data when, for example, setting up connections via the information feed acceptor/listener 410.

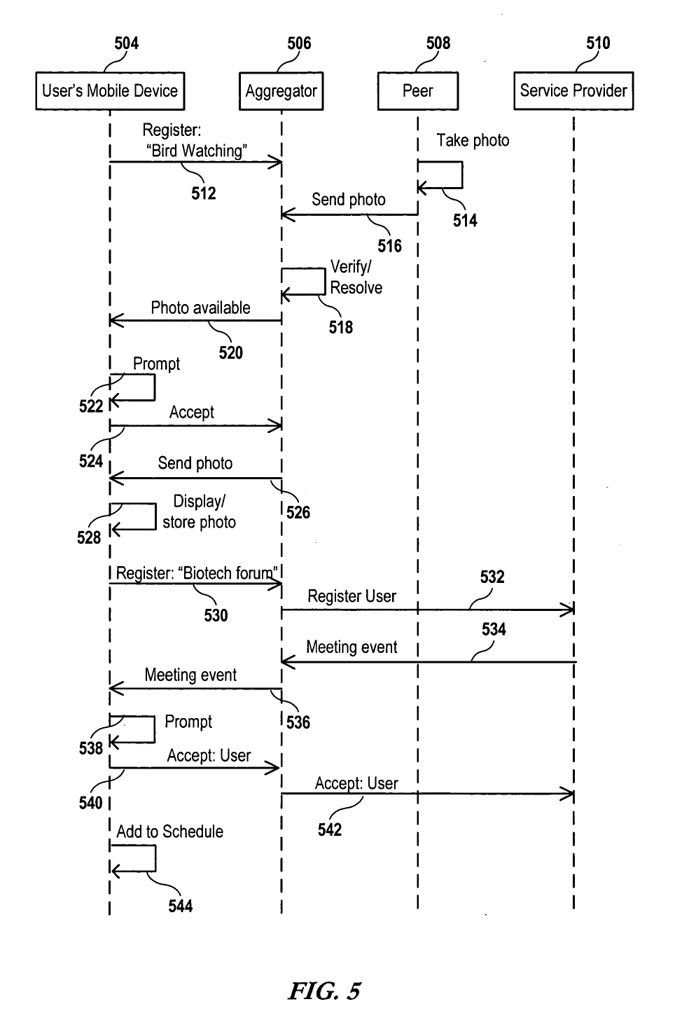

The use of information feeds allows a user to receive narrowly targeted content on a regular basis with a minimum of user interaction required. An example of usage scenarios according to embodiments of the present invention is illustrated in FIG. 5. In this scenario, a user has a mobile device 504 that is configured to receive information feeds. The mobile device 504 is in network communication with an aggregator 506, which may include one or more servers arranged to receive, categorize, resolve, and send out content. The aggregator 506 may also include the needed functionality to manage various aspects of information feeds, including starting/stopping of sessions, feed registration, authorization, security, presence, etc. The aggregator 506 may also be coupled to peers 508 and service providers 510 that generate content for the information feeds.

Initially, the user 504 will select and register 512 for a particular information feed. In this scenario, it is assumed that the user is interested in an information feed regarding bird watching. Various bird watching enthusiasts can contribute bird watching data related to this feed. For example, a peer terminal 508 might take an electronic photo 514 of a rare bird. The peer terminal 508 might include some mechanism for annotating what is in the photo, as well as providing an editor for entering meta-data that describes the photo and/or associates the data with the bird watching information feed. The terminal's user would send the annotated photo 516 to the aggregator 506.

Upon receiving the photo 516, the aggregator 506 can verify and resolve 518 the photo. Verifying and resolving 518 may involve authorizing the identity of the peer 508, verifying the integrity of the photo 516 and associated meta-data, filtering the data to remove objectionable content and/or spam, checking whether the same data has not previously been received, identifying information feeds appropriate for the data, etc. The photo 516 may indicate the appropriate information feed(s) it is targeted for, although the aggregator may be able analyze incoming data, and limit or expand the appropriate destination feeds. For example, if the photo 516 was of a hummingbird, the aggregator 506 would avoid sending the photo to a subset of the bird watching feeds dedicated to cranes. Similarly, if the bird photo 516 was taken in Costa Rica, it may be appropriate to send the photo 516 to an information feed related to Costa Rican wildlife. It will be appreciated that such verification and resolution 518 may be implemented using any combination of machine and human analysis/interaction.

Assuming the aggregator 506 determined 518 that the photo 516 should be sent to an information feed of the user 504, the aggregator 506 may first send a confirmation message 520 to the user 504 in order to verify interest in receiving the photo. This confirmation message 520 may be accepted or rejected automatically based on a user setting, or the user 504 may be prompted 522 to determine whether to accept the photo. The confirmation message 520 may include various pieces of data regarding the photo, such as a description, identity of the originator (e.g., a user ID of the peer 508), a thumbnail image, etc.

Assuming the photo has been accepted either manually or automatically, the user 504 will send an acceptance message 524 to the aggregator 506. The aggregator 506 then sends the photo 526 to the user 504, and the photo can be viewed and/or stored 528 on the terminal. It will be appreciated that the user 504 and aggregator 506 may have an arrangement where no confirmation message 520 is required, such that when the aggregator determines 518 that the photo should be sent to the user 504, the photo is sent 536 either immediately or according to a predetermined schedule.

Another scenario shown in FIG. 5 involves an information feed regarding open biotechnology forums. In this scenario, it is assumed that data related to the biotechnology forums are generated at the service provider 510. The service provider 510 may include a Web host and/or collaborative server acting as a central authority for biotechnology related events. The user 504 can register for this information feed by sending a registration message 530 to the aggregator 506, which forwards the registration 532 to the service provider 510. When the service provider 510 has an event of interest that should be communicated to members (e.g., an upcoming meeting), the notification is sent 534 to the aggregator 506, which forwards 536 this notification to the user 504. Note that, since the service provider 510 is a trusted source, the aggregator 506 may not need to verify or resolve data sent to the information feed. However, where the information feed combines data from multiple service providers 510 and peers 508, then verification may still be necessary, at least to make sure redundant information is not being sent.

Once the notification has been forwarded 536 to the user 504, the usual verification methods such as prompting the user 538 can occur. In this example, acceptance 540 by the user 504 may be sent to the aggregator 506, which forwards the acceptance 542 to the service provider 510. This may allow the service provider 510 to determine amount of interest in the event, prepare attendance/access lists, schedule facilities, etc. The user 504 may also manually or automatically add the meeting 544 to an electronic scheduling program.

Hardware, firmware, software or a combination thereof may be used to perform the various functions and operations described herein of a distributed-computation program. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a distributed-computation system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A method of providing data to a data processing arrangement coupled to a service element via a network, comprising:
selecting a content-defined information feed of the service element;
sending the information feed from the service element to the data processing arrangement;
selecting an application of the data processing arrangement for receiving the information feed based on a predetermined association between a content-type of the information feed and a content-type of the application;
sending the information feed to the application for utilization by the application.

2. The method of claim 1, wherein selecting the application for receiving the information feed comprises:
registering one or more content-types of the application via an application program interface of the data processing arrangement; and
selecting the application for receiving the feed based on the registered content-types.

3. The method of claim 1, further comprising registering, with the service element, one or more content-types associated with applications of the data processing arrangement.

4. The method of claim 1, further comprising
receiving data at the service element from a plurality of data sources;
aggregating the data at the service element; and
forming information feeds of the service element based on the aggregated data.

5. The method of claim 4, wherein the plurality of data sources includes a peer of the data processing arrangement.

6. The method of claim 4, wherein the plurality of data sources includes a service provider.

7. The method of claim 4, wherein the aggregating the data comprises removing redundant data.

8. The method of claim 4, wherein aggregating the data comprises determining content-type associations of the data.

9. The method of claim 1, wherein the data processing arrangement comprises a mobile terminal.

10. A processor-readable medium, comprising:
a program storage device configured with instructions for causing a processor of a data processing arrangement coupled to a service element via a network to perform the operations of,
selecting a content-defined information feed originating from the service element;
receiving the information feed from the service element;
selecting an application for receiving the feed based on a predetermined association between a content-type of the information feed and a content-type of application; and
sending the information feed to the application for utilization by the application.

11. The processor-readable medium of claim 10, wherein selecting the application for receiving the information feed comprises:
registering one or more content-types of the application via an application program interface of the data processing arrangement; and
selecting the application for receiving the feed based on the registered content-types.

12. The processor-readable medium of claim 10, wherein the operations further comprise registering, with the service element of the network, one or more content-types associated with applications of the data processing arrangement.

13. The processor-readable medium of claim 10, wherein the data processing arrangement comprises a mobile terminal.

14. A system comprising:
a network;
a service element coupled to the network and having means for sending information feeds via the network; and
a data processing arrangement coupled to the service element via the network, the data processing arrangement having,
means for selecting a content-defined information feed of the service element;
means for receiving the selected information feed via the network;
means for selecting an application of the data processing arrangement for receiving the feed based on a predetermined association between a content-type of the information feed and a content-type of the application; and
means for delivering the information feed to the application.

15. The system of claim 14, wherein the data processing arrangement further comprises means for registering one or more content-types of the application via an application program interface of the data processing arrangement.

16. The system of claim 14, wherein the data processing arrangement further comprises means for registering, with the service element, one or more content-types associated with applications of the data processing arrangement.

17. The system of claim 14, wherein the service element further comprises:
means for receiving data from a plurality of data sources;
means for aggregating the data; and
means for forming information feeds based on the aggregated data.

18. An apparatus configured for exchanging data with a service element via a network, comprising:
a network interface configured to exchange data with the service element via the network;
a processor coupled to the network interface; and
a data storage arrangement containing one or more applications and an information feed module, the information feed module having instructions that cause the processor to:
select a content-defined information feed of the service element via the network interface;
receive the selected information feed via the network interface;
determine a selected application of the one or more applications for receiving the feed based on a predetermined association between a content-type of the information feed and a content-type of the selected application; and
deliver the information feed to the selected application.

19. The apparatus of claim 18, wherein the information feed module is further configured to cause the processor to:
accept registration of one or more content-types of the applications via an application program interface of the information feed module; and
select the application for receiving the feed based on the registered content-types.

20. The apparatus of claim 18, wherein the information feed module is further configured to cause the processor to register, with the service element, one or more content-types associated with the applications of the apparatus.

21. The apparatus of claim 18, wherein the network interface comprises a wireless network interface.

22. An apparatus configured for exchanging data with a client terminal via a network, comprising:
a network interface configured to exchange data with the client terminal via the network;
a processor coupled to the network interface; and
a data storage arrangement containing instructions that cause the processor to:
receive data from a plurality of data sources via the network;
aggregate the data into one or more content-defined information feeds;
receive from the client terminal a request for one of the content-defined information feeds of the apparatus; and
send to the client terminal the selected information feed via the network interface.

23. The apparatus of claim 22, wherein the plurality of data sources includes a peer of the data processing arrangement.

24. The apparatus of claim 22, wherein the plurality of data sources includes a service provider.

25. The apparatus of claim 22, wherein the aggregating the data comprises removing redundant data.

26. The apparatus of claim 22, wherein aggregating the data comprises determining content-type associations of the data.
